(19) United States
(12) Patent Application Publication
(10) Pub. No.: US 2002/0193351 A1
(43) Pub. Date: Dec. 19, 2002

(54) Fungicidal and bactericidal compositions for plants containing phosphonate and phosphate salts, metal chelates, and derivatives thereof

(76) Inventor: John B. Taylor, DeLand, FL (US)

Correspondence Address: Kenneth D. Goetz, Lathrop & Gage LC, Suite 2800, 2345 Grand Boulevard, Kansas City, MO, 64108, US

(21) Appl. No.: 10/017,687

(22) Filed: Oct. 30, 2001

Related U.S. Application Data
(63) Continuation-in-part of application No. 09/702,417, filed on Oct. 31, 2000.
Application No. 09/702,417 is a continuation-in-part of application No. 09/387,100, filed on Aug. 31, 1999, now Pat. No. 6,139,879.
Application No. 09/387,100 is a continuation-in-part of application No. 08/881,968, filed on Jun. 25, 1997, now abandoned.
Application No. 08/881,968 is a continuation-in-part of application No. 09/419,127, filed on Oct. 15, 1999, now Pat. No. 6,338,860.
Application No. 09/419,127 is a continuation-in-part of application No. 09/109,139, filed on Jul. 2, 1998, now Pat. No. 5,997,910.
Application No. 09/109,139 is a division of application No. 08/812,865, filed on Mar. 6, 1997, now Pat. No. 5,800,837.
Application No. 08/812,865 is a continuation-in-part of application No. 08/705,594, filed on Aug. 30, 1996, now Pat. No. 5,736,164.

(51) Int. Cl. A01N 57/00; A01N 57/10

(52) U.S. Cl. 514/114; 514/143

(57) ABSTRACT

The present invention relates to compositions containing at least one metal chelate, at least one phosphonate salt, and at least one phosphate salt, which are used as fungicides and bactericides, and methods of using the compositions.

### RELATED APPLICATIONS

The present patent application is a continuation-in-part of U.S. patent application Ser.l No. 09/702,417, filed Oct. 31, 2000, which is a continuation-in-part of U.S. patent application Ser. No. 09/387,100, filed Aug. 31, 1999 now U.S. Pat. No. 6,139,879, which is a continuation-in-part of U.S. patent application Ser. No. 08/881,968, filed Jun. 25, 1997 now abandoned and which is a continuation-in-part of U.S. patent application Ser. No. 09/419,127, which is a continuation-in-part of U.S. Pat. No. 5,997,910, which is a divisional of U.S. Pat. No. 5,800,837, which is a continuation-in-part of U.S. Pat. No. 5,736,164.

### FIELD OF THE INVENTION

The present invention is broadly concerned with fungicidal and bactericidal compositions, and methods of use, which provide improved efficacy in controlling fungus and bacterial infections in plants. More particularly, the compositions and methods relate to metal chelates, and preferably to a copper chelate in the form of Cu-EDDHA (copper ethylenediarnine-di-o-hydroxyphenylacetic acid), including an effective amount of phosphate (PO₄) and phosphonate (PO₃), in aqueous solution.

### BACKGROUND OF THE INVENTION

Fungicides, as well as bactericides, are either chemical or biological agents used to protect agricultural crops from infectious pathogens which, if left uncontrolled, result in the weakening or destruction of a plant. In regards to agricultural crops, this is unacceptable, as economic losses will result. Specific pathogens which tend to have an undesired effect on various agricultural crops include Citrus Greasy Spot, Citrus Melanose, Oak Leaf Blister, Erwinia, Xanthomonas, and Alternaria. In the interest of protecting valuable agricultural crops, it is desired to have a fungicide and bactericide composition that readily eliminates or treats these various plant maladies, as well as other infectious agents.

Copper (Cu) compounds that are active as fungicides and bactericides have been in agricultural use since the advent of Bordeaux in the grape vineyards of France in the early 1800s. It has been observed that various types of copper compounds can be used to effectively treat various plant pathogens. As such, many different formulations of fungicides employing copper compounds, such as wettable powders, water based flowables, and dry flowables, are commonly used today in modern agricultural applications. While copper compounds are known to impart desirable fungicidal and bactericidal properties, there are associated problems. Specifically, known copper compounds are typically either phytotoxic, non-soluble, or ineffective as a fungicide or bactericide.

Generally, copper compounds used as fungicides have, for the most part, been inorganic in form when applied to agricultural uses. The inorganic copper compounds have been used because they have been observed to be non-phytotoxic. Organic forms of the copper compounds, while beneficially water soluble, have been found to be generally phytotoxic, especially in foliar applications.

Water soluble, copper compounds such as CuSO₄, though effective to inhibit germination of fungus spores, when used in foliar applications to agricultural crops can be phytotoxic. Therefore, relatively insoluble forms of inorganic copper compounds, such as cupric hydroxide, have been found to be more effective fungicides. Note, however, that not all water insoluble Cu compounds are fungicidal or bactericidal. It is known that the in-vitro fungicidal activity is largely dependent on the copper solubility in the spore exudate and in the fungal cell. Also, despite the phytotoxicity, certain organic copper compounds have some utility as fungicides. An example of a suitable organic copper compound is CUTRINE (Cu salt of tri-ethanol amine) which is quite effective as an aquatic algicide, but unsuitable for use in other foliar applications.

While inorganic copper compounds are beneficially non-phytotoxic, they generally suffer from low water solubility. Modern day agricultural uses of inorganic copper compounds as fungicides employ varying forms of copper compounds having relatively low water solubility and include, for example, cupric hydroxide, tri basic copper sulfate, and tank mix combinations (with heavy metal ethylene-bis-di-thiocarbamate fungicides to enhance the bactericidal activity against certain important agricultural bacterial such as Xanthomonas, Pseudomonas, and Erwinia). The lack of solubility of the inorganic copper compounds is an undesirable problem. Because known and popular copper fungicides are largely water insoluble, they are normally applied in relatively large volume aqueous suspensions and, as such, are readily removed by rain after application. Frequent applications are, thus, necessary at short intervals—an application process which is expensive and environmentally imprudent.

Inorganic copper compounds alone are also not particularly effective in treating certain forms of fungus known as Phytophthora. From 1845 to 1846, the Irish Potato Famine occurred, which was one of the most devastating crop failures in the history of the world. The potato famine was caused by the disease late blight which resulted in harvested potatoes quickly decaying, making them unsuitable for consumption. The disease is also known to cause defoliation in infected plants. Late blight is caused by a Phytophthora infestans infecting potato and tomato plants. As can be gathered, the Phytophthora fungus, if not controlled, can cause major economic damage to agricultural crops, with the resulting damage causing the loss of millions of dollars in crop revenues. Additionally, there is the possibility of significant reduction of the potato and tomato supply available to consumers.

To control late blight, it has been recommended that the contaminated potatoes and/or tomatoes be buried in deep pits and covered by at least two feet of soil. In Northern Latitudes, the potatoes or tomatoes can be spread on the soil surface and allowed to freeze during the winter. These methods temporarily prevent the spread of the disease, but do not prevent infection and attack by the Phytophthora infestans. The treatment only addresses plants and crops after they have been destroyed. For this reason, it is desired to have a composition or method that can be administered to potato and tomato fields to actively control and prevent the spread of the Phytophthora infestans infestation.

Some species of the Phytophthora genus can be controlled, such as Phytophthora parasitica. In particular, fosetyl-al (ethyl phosphonate) can be administered to plants to control diseases such as root rot caused by Phytophthora parasitica. As such, it is known that many phosphonate (PO₃) compositions are highly effective in combating the disease root rot and, in particular, some of the species of the genus Phytophthora. Unfortunately, fosetyl-al and other phosphonates, alone, do not control late blight and similar Phytophthora diseases caused by the species Phytophthora sojae. Thus, it is desired to have a method or composition that readily inhibits infection by and proliferation of Phytophthora infestans.

Phosphorus is an essential element in plant nutrition because it governs the energy producing reactions, including those that are oxidative and photo phosphorylative. Phosphorous is essential to the production of adenosine diphosphate (ADP) and adenosine triphosphate (ATP). Energy-rich phosphate bonds of ADP and ATP provide the energy for many of the physiological reactions that occur in plants. As such, various forms of phosphorous are absorbed by plants for use as part of the photosynthetic process.

The element phosphorous appears in numerous general forms, including phosphonate (PO₃) and phosphate (PO₄). The term “phosphonate,” sometimes also referred to as “phosphite,” means the salts (organic or inorganic) of either phosphonic acid or phosphorous acid. Phosphonic and phosphorous acids have the formula H₃PO₃ and a molecular weight of 82.00. Their structures from the International Union of Pure and Applied Chemistry are shown below:

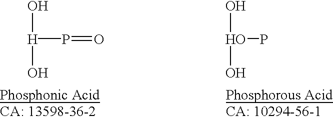

The term “phosphate” means the salts (organic or inorganic) of phosphoric acid having the formula H₃PO₄, molecular weight of 98.00 and having the following structure:

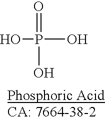

In the past, various phosphonate compounds have been proposed as useful in fungicidal and fertilizer compositions for application to plants. See, e.g. U.S. Pat. Nos. 4,075,324 and 4,119,724 to Thizy, describing phosphorous acid, its inorganic and organic salts, as a plant fungicide; U.S. Pat. No. 4,139,616 to Dueret, describing fungicidal compositions based on phosphorous acid esters and salts thereof; U.S. Pat. No. 4,542,023 to Lacroix et al., describing organophosphorous derivatives as possessing systemic and contact fungistatic and fungicidal activity; U.S. Pat. Nos. 4,698,334, 4,806,445, and 5,169,646 to Horriere et al., describing fungicidal compositions based on alkyl phosphonates; U.S. Pat. Nos. 4,935,410 and 5,070,083 to Barlet, describing fingicidal aluminum tris-alkyl-phosphonate compositions; and U.S. Pat. No. 5,514,200 to Lovatt, describing formulations of phosphorous-containing acid fertilizer for plants. (The teachings of the proceeding U.S. Patents are hereby incorporated by reference.) The above references, disclosing phosphonate compositions, have been found to be effective for protecting plants and, particularly, grape vines, citrus and fruit trees, and tropical plants against fungal attack.

Note that phosphonate (PO₃) alone is typically considered an unacceptable source of phosphorus (P) for plants. It is known that PO₃ must be converted to PO₄ to be utilized by a plant.

Once assimilated, phosphonates (PO₃) have been shown to enhance the plant's phytoimmune system. The phosphonate induced stimulation of the phytoimmune system is triggered by the induction of ethylene production, followed by a rapid accumulation of phytoalexins at the site of infection. Phytoalexins are antibiotics which result from the interaction between the host plant and a pathogen. The phytoalexins are synthesized by and accumulate in the plant to inhibit the pathogen. The phytoalexins will accumulate at the site of an infection to prevent further spread of the disease, thereby reducing symptomatic expression of the disease.

In the past, phosphates (PO₄) were not viewed as a solution to pathological acerbation of fungal infections or infections produced by other genera. This is because phosphates (PO₄) are viewed primarily as a fertilizer with only limited, or even detrimental, phytoimmune properties. For example, U.S. Pat. No. 5,514,200 teaches that phosphate fertilizers inhibit beneficial symbiosis between plant roots and mycorrhizal fungi, and further promote bacterial and fungical growth in the rhizosphere, including the growth of pathogenic fungi and other soil-borne organisms. (Col. 2, lines 18-28). Phosphates (PO₄) have also been considered to be a competitive inhibitor for phosphonate assimilation, thus inhibiting the ability of phosphonates (PO₃) to protect against fungus attack. See, Pegg, K. G. and deBoer, R. F., “Proceedings of the Phosphonic (Phosphorous) Acid Work Shop,” Australiasian Plant Pathology, Vol. 19 (4), pp. 117 and 144, 1990. Yet further, phosphonates (PO₃) and phosphates (PO₄) were believed to be “biological strangers,” with the presence of phosphonates (PO₃) or esters of phosphonates, exerting little or no influence on enzyme reactions involving phosphates. Robertson, H. E. and Boyer, P. D., “The Biological Inactivity of Glucose 6—phosphonate (PO₃), Inorganic Phosphites and Other Phosphites,” Archives of Biochemistry and Biophysics, 62 pp. 380-395 (1956).

Thus, both forms, inorganic and organic Cu compounds, as well as phosphates (PO₄) and phosphonates (PO₃) when used individually, suffer from problems. Therefore, the need exists for a highly water soluble Cu compound based fungicide and bactericide that is not phytotoxic. A need also exists for a water soluble Cu compound based fungicide and bactericide that reduces the adverse Cu load on the plant, thus reducing the non-target impact to the environment. Further, a need exists for such fungicidal and bactericidal compounds that permit use of other metals such as manganese, zinc, iron, copper and mixtures thereof, as may be desired for specific fungicidal or bactericidal properties.

Also, the requirements for a successful phosphonate-based fungicide depend on the promotion of the phosphonate-induced pathological acerbation of fungical or other genus infections. More particularly, it is desired to have a composition and/or method that prevents Phytophthora infestans infection and destruction of plants.

### SUMMARY OF THE INVENTION

The present invention relates to a metal chelate fungicide and bactericide composition that also includes effective amounts of phosphate PO₄) and phosphonate (PO₃), and methods of using the composition to control fungicidal and/or bactericidal infection in plants. Preferably, the chelate is a composition that is a member of the EDDHA (ethylenediamine-di-o-hydroxyphenylacetic acid) family, and the metal is selected from the group consisting of iron, copper, manganese, zinc, tin, and combinations thereof. Copper, however, is the most preferred metal. Importantly, the present invention addresses the problems discussed before, of solubility, phytotoxicity, and effectiveness. In particular, the fungicide and bactericide composition of the invention provides an improved antifungal and antibacterial composition for use on plants that contains, as active ingredients, fungicidally and/or bactericidally effective amounts of the metal chelates, phosphonates, and phosphates in aqueous solution. It has been observed that the application of the composition of the invention to a plant substantially eliminates fungus and bacteria disease. Not only is the composition effective in eliminating fungus and bacteria, but it is substantially non-phytotoxic. Also, the metal chelate in the composition of the invention is soluble in aqueous solution. Thus, the composition provides for protection of plants against fungal and bacterial infections without the attendant phytotoxicity.

Importantly, the composition of the invention is a singular product that imparts antifungal and antibacterial protection upon application without being phytotoxic. The composition of the invention is, additionally, environmentally safe, comparatively inexpensive to use, and has low mammalian toxicity.

Essentially, the present antifungal and bacterial composition is comprised of an active material, a fungicidally and/or bactericidally effective amount of a metal chelate, and an agriculturally acceptable carrier, such as water. The preferred fungicidal and bactericidal compositions is comprised of water and a metal chelate selected from the group consisting of Fe-EDDHA (iron ethylenediamine-di-o-hydroxyphenylacetic acid), Cu-EDDHA, Mn-EDDHA, Zn-EDDHA, Sn-EDDHA, and mixtures thereof. Other family members of EDDHA can be substituted therefor, including pEDDHA and EDDHMA. Desirably, both antifungal and antibacterial effects are achieved with one composition.

The composition of the invention also includes phosphate (PO₄) and phosphonate (PO₃) constituents which, when combined, particularly provide for a synergistic effect that results in the substantial protection against infection of plants by Phytophthora, especially Phytophthora infestans. As such, the phosphate and phosphonate constituents can be combined to form a composition, which can be applied to plants, especially tomatoes and potatoes, to prevent infection by Phytophthora infestans and diseases caused by such infection. Application can be achieved by using either a dry mix or an aqueous solution.

The preferred composition for preventing Phytophthora will be comprised of at least one potassium phosphonate and at least one potassium phosphate, as it has been found that these two constituents, when combined, will cause a synergistic effect which results in the substantial prevention of infection by Phytophthora. It is believed, that the rate by which infection is prevented is increased by at least 100% when the two constituents are combined, as compared to the additive effect of the combined salts. The two constituents will be combined in an amount sufficient to prevent infection and manifestation by various disease causing organisms, with the particular amounts combined dependent upon the particular species of plant to be treated, the specific disease causing organism to be treated, and the particular phosphate salt and phosphonate salt that will be combined.

The composition should be applied at least once to the plants to be treated. While one application is sufficient, it is typically preferred to make multiple applications. Essentially, any plant infected by Phytophthora can be treated, with it most preferred to apply the composition to potato and tomato plants. It should also be noted that the composition not only inhibits Phytophthora, but is environmentally safe, inexpensive to use, and has low mammalian toxicity.

Phosphonate salts useful in the practice of the invention also include those organic and inorganic salts taught by U.S. Pat. Nos. 4,075,324 and 4,119,724 to Thizy et al., (see, e.g., col. 1, In. 51-69 through col. 2, In. 1-4).

### DETAILED DESCRIPTION

The present invention relates to a composition that is both a fungicide and a bactericide and a method for using such composition. The composition is advantageously useful in eliminating or at least substantially reducing the effects of infection by various fungal and bacterial plant pathogens. The composition of the invention contains at least one metal chelate in aqueous solution, with it preferred that the chelate be a member of the EDDHA family of compositions, at least one phosphonate salt, and at least one phosphate salt. The metal attached to the chelate can be selected from any of a variety of metals, especially those selected from rows 4 or 5 of the periodic table of the elements, particularly metals of row 4.

As stated, one component of the present composition is a metal chelate, preferably in an amount of water to form an aqueous composition. The metal chelate can be formed by a known process, with the reaction summarized as reacting an amount of metal chloride hexahydrate with water and an amount of mono-amide di-hydrochloride in a reaction vessel. A catalyst, such as sodium hydroxide, is then added which will cause formation of the metal oxide EDDHA. Among the metal hexahydrates that can be reacted with the mono-amide di-hydrochloride are iron, zinc, tin, manganese, and copper, preferably zinc, manganese, and copper, and more preferably copper. The resulting metal chelates that are suitable for use include: Fe-EDDHA, Cu-EDDHA, Zn-EDDHA, Mn-EDDHA, Sn-EDDHA, and combinations thereof. In addition, the corresponding metal chelates of para-ethylenediamine-di-o-hydroxyphenylacetic acid (pEDDHA), ethylenediamine-di-o-hydroxyphenylmethylacetic acid (EDDHMA), and combinations thereof are also particularly suitable for use.

The term “metal chelate” refers to an organic coordination “complexing” compound in which a metal ion is bound to atoms of non-metals, e.g., nitrogen, carbon, or oxygen, to form a heterocylic ring having coordinate covalent bonds. The non-metal atoms may be attached to the metal ions by from one to six linkages and, thus, are called uni, bi, tri dentate, etc., meaning 1-, 2-, or 3-tooth. Suitable metals commonly involved in chelate structures include those metals selected from rows 4 or 5 of the periodic table of the elements, particularly metals of row 4. Examples of suitable metals include, but are not limited to, cobalt, copper, iron, nickel, zinc, tin, and manganese, preferably copper, iron, zinc, and manganese, more preferably copper, zinc, and manganese, and most preferably copper. Examples of specific metal chelate structures include:

Fe-HEEDTA (hydroxyethylethylenediaminetriacetic acid), Fe-EDTA (ethylenediaminetetraacetic acid), Fe-DTPA (di-ethylenetriaminepentaacetic acid), Fe-EDDHA (ethylenediamine-di-o-hydroxyphenylacetic acid), ethylene-bis-di-thiocarbamates of Mn and Zn (EBDC), Cu-EDDHA, Mn-EDDHA, and Zn-EDDHA.

To form the metal chelate aqueous composition the metal chelate will be mixed with an amount of water to form an aqueous solution. Generally, special treatment of the water is not required, such as deionizing the water for example. Additionally, the mixing will preferably occur under ambient conditions. The metal chelate will be mixed into the water in an amount sufficient to cause the finished composition to equal from about 0.01 pounds to about 2.0 pounds of AI (active ingredient, i.e. the metal) per acre. Preferably, the amount of metal chelate is about 0.01 to about 0.8, and more preferably about 0.01 to about 0.2 pounds of AI per acre. Typically this means adding the metal chelate to the water in an amount equal to between about 1% and about 5% by weight (on a metal basis) of the total solution. More preferably, the metal chelate will be added in an amount equal to between about 2% and about 4% by weight, and most preferably about 3% by weight of the total solution.

Once the aqueous composition has been formed by thoroughly blending the phosphonate salt, phosphate salt, and metal chelate with the water, the aqueous composition is then ready for application to plants, in particular agricultural crops. The aqueous composition is typically easily applied by spraying or other means of distributing the aqueous solution in a sufficient amount to the plants.

The metal chelate must be applied in a sufficient AI amount, without resulting in phytotoxicity. Unacceptably high levels of phytotoxicity result in foliar burn, defoliation and stem die-back, necrosis, plant stunting, or death. Phytotoxicity can be rated on an international scale of 0-10 where 0 is equal to no phytotoxicity and 10 is complete death of the plant. It is preferred if the metal chelate is applied in an amount so that the phytotoxicity is minimized.

Phytotoxicity rankings of Fe chelates, for example, used in foliar applications are as follows: Fe-HEEDTA—most phytotoxic; Fe-EDTA—intermediate phytotoxic, Fe-DTPA—less phytotoxic, and Fe-EDDHA—least phytotoxic. Thus, the Fe-EDDHA is preferred because it is the least phytotoxic while still imparting excellent fungicidal and bactericidal properties.

Metal chelates disclosed herein will have a water solubility acceptable for use in the inventive fungicide and bactericide. For example, the solubility of sequestrene 138 Fe Iron Chelate in pounds per 100 gallons of water, at various temperatures is similar to the present metal chelate in aqueous solution. (Solubility weight/100 gals. H₂O) is shown in Table 1 below:

| TEMPERATURE (° C.) | LBS. | OZ. |
|---|---|---|
| 0 | 69 | 11 |
| 10 | 70 | 7 |
| 20 | 75 | 4 |
| 30 | 81 | 11 |
| 40 | 84 | 1 |
| 50 | 88 | 1 |

Commercially produced Sequestrene 138 Fe contains 6% Iron as metallic, or 8.5% iron as Fe₂O₃. The commercial product has a moisture content of not more than 10%. As such, this is exemplary of a suitable solubility. Thus, it is desired for the metal chelate, in particular the Cu-EDDHA, to have a solubility of about 100% where at least 80 lbs. of metal chelate is dissolved in 100 gallons of H₂0 at 50° C.

Without being limited to this theory, it is believed that metal chelation generally increases the water solubility of the metal ion and the availability in certain soil conditions of the metal ion where calcareous and high pH situations would otherwise prevent metal ions from being available to the plant as a fungicide.

It is believed that certain metal chelates (usually in the form of Mn, Zn, and Fe) may be applied foliarly at much reduced rates when compared to inorganic salts intended for fungicidal use.

The preferable method of application is foliar, either by ground or aerial equipment, but is not limited to that method alone. Injection or soil applications, for example, can also be used depending upon the specific crops and pathogens.

Among the plants that can be treated with the metal chelate in aqueous solution are: fruit crops, and agronomic crops, ornamentals, trees, grasses, vegetables, grains, and floricultural crops, as well as, some aquatic crops, including rice.

The fungicidal and bactericidal properties of the compounds according to the invention are various, but are particularly interesting in the cases described in the following examples.

The following examples set forth preferred concentrations and techniques for formulation thereof, as well as methods of application and use in test results, demonstrating the efficacy of the inventive concentration in protecting plants against attack by fungi or bacteria, or both. It is to be understood, however, that these Examples are presented by way of illustration only, and nothing therein shall be taken as a limitation upon the overall scope of the invention. The specific components tested in the Examples were prepared and applied as follows:

To prepare Cu-EDDHA, an appropriate Cu salt need merely be substituted for the iron salts as discussed before and disclosed in U.S. Pat. No. 2,921,847, which is incorporated herein by reference.

As used in the Examples, “Ave. % infection” means percent of leaves that exhibit fungus lesions.

### EXAMPLES

### Example 1

Cu-EDDHA and four commercially accepted fungicidal compositions were applied to Valencia orange on sour orange rootstock. Applications were in 100 gallons of solution (in the concentrations indicated in the table below) per acre in mid-summer to single-tree plots replicated six times in a randomized complete block (“RCB”) design. Seven months later, the percentages of Citrus Greasy Spot infection on five branch terminals from each tree were recorded and averaged.

CITRUS GREASY SPOT TEST
CAUKINS GROVES, INDIANTOWN, FLORIDA

| | | *AVE % INFECTION |
|---|---|---|
| TREATMENT | RATE/100 GALLONS | 2/10/88 |
| FCC-455 Spray Oil | 1% | 30.0 |
| (Florida Citrus | | |
| Commission) | | |
| Difenconazole | 50 gram (gm) AI | 1.56 |
| Difenconazole | 100 gm AI | 1.0 |
| Cu-EDDHA 3.2% | 0.2 lbs. AI | 2.5 |
| KOCIDE 101 | 4 lbs. | 23 |
| Untreated | — | 35 |

APPL. Single tree plots × 6 Reps.
*Aug. 5 terminals/tree

The Difenconazole (triazole): specifically, 1-2[2-[4-(4-chlorophenoxy)-2-chlorophenyl-(4-methyl-1, 3-dioxolan-2-l)-methyl]]-1H-1 ,2,4-triazole (available from Ciba-Geigy, Greenborough, N.C.) is a triazole fungicide. As can be seen, from the table it provided desirable fungus repression. But, triazole is well known to be potentially hazardous to human health, in particular it is known to be damaging to the human liver.

Also tested, was Cu-EDDHA: (Sodium cupric ethylenediamine-di-o-hydroxyphenylacetic acid), which is the fungicide/bactericide of the present invention. Analysis of the data shows excellent results from applying the Cu-EDDHA.

KOCIDE 101 is a fungicide available from Griffin Corp., Valdosta, Georgia. The composition FCC-455 spray is also fungicide. The % infection of the plants treated with the KOCIDE 101 and FCC-455 compositions is considered unacceptable. Also, note that KOCIDE 101 is a copper hydroxide composition.

From the table AVE % infection relates to the percentage infection of Citrus Greasy Spot (Mycosphaerella citri) found on the treated leaves.

### Example 2

In the present Example, fungicides were again tested on “Valencia” oranges except the effect of various fungicides on perithecia was tested. Three different fungicides, the Cu-EDDHA, TILT (Propiconazole made by Ciba-Geigy), and difenconozole were applied in 100 gallons per acre (gpa) to single tree plots of “Valencia” oranges replicated five times in a RCB design in mid-July.

Twenty mature leaves (from the spring flush) per replicate were harvested approximately 4 months later and placed under greenhouse conditions and alternately wetted and dried to simulate natural defoliation and weathering.

These conditions, in turn, cause the fungus to sporulate by the formation of perithecia (spore production body of fungus). The spores were counted as a means of measuring the fungicidal activity of the treatments. The data is presented below.

CITRUS GREASY SPOT
SCN NURSERY, DUNDEE, FLORIDA

| TREATMENT | RATE/100 GALLONS | | #PERITHECIA |
|---|---|---|---|
| Cu-EDDHA 3.2% | 0.2 | lbs. AI | 3.24 b |
| Cu-EDDHA 3.2% | 0.4 | lbs. AI | 5.93 ab |
| TILT 3.6 EC | 6 | oz. Prod. | 6.62 ab |
| Difenconazole | 100 | gm AI | 5.32 ab |
| Difenconazole | 200 | gm AI | 11.57 ab |
| CONTROL inoculated | | | 7.97 ab |
| CONTROL not inoculated | | | 6.42 ab |

The conditions of the test were as follows:

Function: ANOVA-1

Date Case No. 1 to 42

Without selection

One way ANOVA grouped over variable 1

Treatment Number

With values from 1 to 7

Variable 3

Number of Perithecia Per 5 MM Field at 2.5×—Mean of Three Observations

As used herein, a, b, c, and ab indicate statistical significance using Duncan's multiple range test. In interpreting the data, a different notation, e.g. b versus ab, means there was a statistically significant difference in the results. A difference in data of samples with the same letter notation was not statistically significant.

The tests produced important data because if the perithecia is reduced then it follows that the number of infections are reduced. The Cu-EDDHA showed good results. The TILT also showed decent results, but is not preferred because it has limited uses as promulgated by the FDA (Food and Drug Administration). Also, note that Cu-EDDHA added in a higher AI did not result in enhanced repression of the perithecia. This seems to indicate that if too much Cu-EDDHA is added, slight phytotoxicity will result.

ANALYSIS OF VARIANCE TABLE

| | DEGREES | | ERROR | | |
|---|---|---|---|---|---|
| | OF | SUM OF | MEAN | | |
| | FREEDOM | SQUARES | SQUARE | F-VALUE | PROB. |
| Between | 6 | 226.6508 | 37.78 | 1.33 | .270 |
| Within | 34 | 965.0170 | 28.38 | | |
| Total | 40 | 1191.6678 | | | |

### Example 3

Cu-EDDHA, KOCIDE 101 (cupric hydroxide), and difenconazole were applied to single tree plots of “Hamlin” oranges in 100 gpa (in concentration indicated) in a RCB design replicated 4 times. Applications were made in either May, June or May, and June. Ten fruit/replicates were sampled in July and percent infection of Melanose (Diaporthe citri) was determined. See data presented below.

CITRUS MELANOSE CONTROL
R.E. KEENE FRUIT COMPANY

| | RATE, | | % INFECTION |
|---|---|---|---|
| TREATMENT | LB AI/100 GALLONS | TIMING | (FRUIT) |
| Cu-EDDHA 3.2% | 0.2 | May | 9 |
| Cu-EDDHA 3.2% | 0.4 | May | 13 |
| Cu-EDDHA 3.2% | 0.8 | May | 21 |
| Cu-EDDHA 3.2% | 0.2 | May-June | 11 |
| Cu-EDDHA 3.2% | 0.4 | May-June | 15 |
| Cu-EDDHA 3.2% | 0.8 | May-June | 29 |
| Cu-EDDHA 3.2% | 0.2 | June | 14 |
| KOCIDE 101 | 4.0 | May | 12 |
| KOCIDE 101 | 0.4 | May-June | 10 |
| DIFENCONAZOLE | 0.5 | June | 4 |
| Untreated | — | — | 38 |

4 REPS SINGLE TREE PLOTS.

PENETRATOR (surfactant-non-ionic) @4 oz. ALL TREATMENTS

The results indicate that in general not too much Cu-EDDHA should be applied to the plants. Also, an appropriate application time of year such as May, should be chosen.

### Example 4

In the present example, GRAPEFRUIT plants (Citrus paradisi ‘Marsh’) were tested with various fungicides to determine the effectiveness in eliminating greasy spot, Mycosphaerella citri.

Spray treatments were applied dilute (applied to point of run off) by handgun in July to 10-foot high trees at a rate equivalent to 700 gpa. Treatments were replicated on 8 single tree plots in a RCB design. Groups of 15 shoots on each of the east/west and east side of each tree were tagged and the initial number of leaves was recorded. In February, remaining leaves were counted and examined for greasy spot.

| TREATMENT AND | | % REMAINING LEAVES |
|---|---|---|
| RATE/100 GALLONS | DEFOLIATION | WITH GREASY SPOT |
| Tribasic copper sulfate | 1.9 a | 20.1 a |
| (53% Cu) 0.75 lb. | | |
| Sunspray 7E oil 1 gal. | 3.1 a | 27.0 a |
| Difolatan 80 Sprills | 8.9 b | 49.8 b |
| 1.25 lb. | | |
| Spotless 25W 0.8 lb | 1.3 a | 22.6 a |
| Tilt 3.6EC 8 fl. oz. | 1.5 a | 15.9 a |
| Cu-EDDHA (3.2% Cu) | 0.8 a | 12.0 a |
| 1.5 gal. | | |
| Untreated | 9.7 b | 48.5 b |

All treatments, except Difolatan (fungicide), reduced greasy spot-induced defoliation and the percentage number of remaining leaves with greasy spot symptoms. There were no significant differences in effectiveness between Tribasic copper sulfate, spray oil, Spotless, Tilt, and Cu-EDDHA. There was too little greasy spot rind blotch in this test to provide information on the relative efficacy of treatments for preventing fruit infection.

Copper sulfate is phytotoxic so that it needs to have its phytotoxicity reduced. This is accomplished by combining CaOH with the CuSO₄. Unfortunately, this reduces solubility.

### Example 5

Cu-EDDHA, TILT (propinconazole), difenconazole, and MERTECT ((Merck Chem., N.J.) thiabendazole) were applied in 100 gpa to 2-year-old laurel oaks (Quercus hemispherica) in 2×2 gal. pots in a RCB design replicated 4 times. MERTECT is a standard well known fungicide that does not include copper. Applications were made in July approximately 3 weeks apart and rated in August a month later. See data below.

OAK LEAF BLISTER (Taphrina Caerulescens) CONTROL
TRAILRIDGE NURSERY, KEYSTONE HEIGHTS, FLORIDA

| | RATE, | |
|---|---|---|
| TREATMENT | PRODUCT/100 GALLONS | *DISEASE INDEX |
| Tilt 3.6 emulsifiable | 8 oz. | 1.5 |
| Difenconazole 3.6 | 2 oz. | 2.25 |
| emulsifiable | | |
| Cu-EDDHA 3.2% | 8 oz. | 2.8 |
| MERTECT | 8 oz. | 1.5 |
| Untreated | — | 4.25 |

*Disease Index:
1 = no disease
2 = light
3 = moderate
4 = heavy
5 = dead foliage
2 × 2 gal. trees/exp. unit × 4 Reps in a RCB design

As can be seen, suitable disease repression occurred with the Cu-EDDHA composition, event though the concentration is higher than the preferred cmount.

### Example 6

Cu-EDDHA and Kocide (cupric hydroxide) were applied as foliar spray in May Hibiscus sinensis cuttings (100/replicate)×4 replicates in a RCB design. Treatments were allowed to dry for one hour and then placed in a commercial propagation bed under intermittent mist and rated for bacterial (Erwinia chrysanthemi) infection one week later. Data is presented below:

*ERWINIA CONTROL ON HIBISCUS
NELSONS NURSERY, APOPKA, FLORIDA

| | RATE, | |
|---|---|---|
| TREATMENT | Cu/100/GALLONS | AVERAGE % INFECTION |
| Cu-EDDHA 3.2% | 0.2 lb. AI | 6 |
| Cu-EDDHA 3.2% | 0.4 lb. AI | 8 |
| Kocide 101 | 2 lbs. AI | 25 |
| Untreated | — | 100 |

100 Cuttings/REP X 4 *ERWINIA Chrysanthemi

The Cu-EDDHA added in an amount equal to 0.2 1b. AI showed excellent control of Erwina on Hibiscus.

### Example 7

A follow-up experiment to Example 6 was conducted on rooted cuttings which were dipped as they were removed from the propagation bed and foliarly sprayed 7 days later after being potted. Cu-EDDHA and Kocide 101 were applied at the rates specified below in a RCB design utilizing 100 plants/replicate x 4 reps. Potted cuttings had not received any previous bactericide treatments prior to potting.

ERWINIA CONTROL ON HIBISCUS
NELSONS NURSERY-APOPKA, FLORIDA

| | RATE, | AVERAGE |
|---|---|---|
| TREATMENT | LB. AI/100 GALLONS | % INFECTION |
| Cu-EDDHA 3.2% | 0.2 | 19 |
| Cu-EDDHA 3.2% | 0.8 | 32 |
| KOCIDE 101 | 2.0 | 22 |

APPLIC. DATES: Jul. 19 DIP, Jul. 26, 1985 SPRAY
100 PLANTS/REP. × 4

Again excellent control was achieved with Cu-EDDHA applied in an amount equal to 0.2 lb. AI.

### Example 8

The present Example relates to controlling bacterial spots on pepper plants. The procedure for the present Example was as follows: Early Cal Wonder variety pepper plants were treated at weekly intervals with the following bactericides (g AI/liter in parentheses): copper+mancozeb (2+1), Cu-EDDHA (0.1), CGA (Ciba Geigy American)-115944, CGA-151731, CGA-157566, and CGA-164058 (each at 0.25 and 0.5), CGA-143268 (1.0). Treatments were applied weekly in 1000 1/ha for a total of eight applications. The crop was artificially inoculated after the first and third applications. Disease severity was evaluated after the fourth and eighth applications. Phytotoxicity was rated after the eighth application and yields were taken continually during the test.

The results of the testing were determined as such: Disease pressure was moderate and uniform. After four applications, the best treatments were CGA-115944, CGA-151731, and CGA-164058. CGA-157566 was less effective than the three previously mentioned compounds, but more effective than CGA-143268 which was equal to copper plus mancozeb and Cu-EDDHA in activity. The ranking of compounds changed when treatments were rated 12 days after the last application. Copper plus mancozeb control has completely broken down, which was expected because disease conditions were severe in the final half of the test and copper should be applied on a five-day schedule under these conditions. Cu-EDDHA at only 0.05× the rate of Kocide 101 (on a metallic copper basis) exhibited some control and was equal to CGA-143268, CGA-157566, and CGA-164058. The best bactericide at the second rating were CGA-115944 and CGA-151731. The phytotoxicity of all treatments was assessed after eight applications had been made. The only bactericides which were phytotoxic were CGA-115944 and CGA-164058. CGA-164058 was safer than CGA-115944, which was marginally unacceptable at 0.5 g AI/1. CGA-143268 and CGA-164058 increased yields dramatically. Yields were depressed by CGA-115944, CGA-151731, and CGA-157566. Cu-EDDHA had no effect on yield and copper+mancozeb increased yields moderately.

### Example 9

Croton plants inoculated with Xanthomonas were tested with various fungicides. Cu-EDDHA at 0.2 and 0.4 lbs. AI/100 gal. and Kocide 101 at 7.4 lbs. AI/Acre (A) were applied as foliar applications to croton (Codiaeum variegatum) previously inoculated with Xanthomonas campestris a day earlier. Treatments were assigned in a RCB design and replicated 10 times with single pots. Treatments were applied 3 times on a weekly schedule and evaluated at 7 and 14 days following the last application. See data below.

Test 1
Codiaeum Inoculated with Xanthomonas
Number of leaves with symptoms

| | RATE, AI/100 | | AVERAGE % OF | |
|---|---|---|---|---|
| TREATMENT | GALLONS | | INFECTION | |
| Water | noninoculated | | 0 | a |
| Water | inoculated | | 2.6 | c |
| Cu-EDDHA 3.2% | 26 ml | (.2 lb.) | .6 | ab |
| Cu-EDDHA 3.2% | 52 ml | (.4 lb.) | 1.0 | b |
| Kocide 101 | 6.8 ml. | (7.4 lb.) | .9 | ab |

ANOVA table

| SOURCE | SUM OF SQUARES | DF | MEAN SQUARE | F VALUE |
|---|---|---|---|---|
| Treatment | 37.28 | 4 | 9.319 | 9.177 |

| | | | |
|---|---|---|---|
| | | | significant at 1% level |
| Error | 45.7 | 45 | 1.016 |
| Total | 82.98 | 49 | |

It was determined that all of the copper treatments provided some control of Xanthomonas leaf spot of Codiaeum, when compared to the inoculated control. The lower rate of Cu-EDDHA and the Kocide 101 gave control equal to the noninoculated control treatment.

### Example 10

In the present example, carrots were inoculated with the Alternaria fungus. The carrots were then treated with the below listed fungicidal compositions. Also a control test was conducted. The percentage of the fungicide in the solution is also listed below along with the results. Plot size for testing was a single row of 25 feet by 4 repetitions in an RCB design. The fungicide was applied eight (8) times with the carrots then examined for infection seven (7) days and twenty-five (25) days after the last fungicidal treatment.

CARROT/ALTERNARIA FUNGICIDE TRIAL

| | | AVERAGE % OF | |
|---|---|---|---|
| | RATE, AI/100 | INFECTION | |
| TREATMENT | GALLONS | 04/05/96 | 04/23/96 |
| 1) K₂HPO₄ | 1 gal. (0.53 wt. % AI) | 6.9 | 8.2 |
| 2) K₂HPO₃ | 1 gal. (0.55 wt. % AI) | 18.7 | 28.8 |
| 3) K₂HPO₄ | 0.5 gal. (0.26 wt. % AI) | 8.9 | 10.7 |
| + | + | | |
| K₂HPO₃ | 0.5 gal. (0.27 wt. % AI) | | |
| 4) Cu—EDDHA | 0.2 lb AI | 8.8 | 11.6 |
| 5) Fe—EDDHA | 0.2 lb AI | 12.7 | 12.9 |
| 6) CONTROL | — | 23.0 | 34.8 |

*EDDHA (Ethylenediamine-di-o-hydroxyphenylacetic acid)

PLOT SIZE: Single Row×25 ft.×4 reps in a RCB design. Application dates: 2/2, 9,15,22,3/8,14,22, and 28. Rated 4/5 and 4/23/96

NOTE: Second rating was 25 days after last fungicide application. Plots were inoculated with Alternaria dauci.

The tests were conducted in Sanford, Fla.

As can be seen, Cu-EDDHA effectively limited percentage of fungicidal infection. It can be concluded that the Cu-EDDHA as well as the Fe-EDDHA are effective fungicides.

The above Examples demonstrate that the EDDHA metal chelate compositions are useful in protecting plants against attack by fungus with the application of the EDDHA metal chelate solution.

It will be further appreciated that foliar application of the EDDHA metal chelate compositions will be effective as a common agricultural practice to control bacterial infections in plants.

It will be appreciated by those skilled in the art that beneficial effects demonstrated in the Examples by the use of Cu-EDDHA will also be obtained when the Mn, Sn, Fe, and Zn EDDHA form metal chelates are employed.

The present invention also relates to compositions and methods for use in preventing diseases, such as late blight, caused by the genus Phytophthora. In particular, the present invention relates to compositions and methods for use in preventing plant diseases caused by Phytophthora infestans. The composition of the invention comprises at least one phosphate (PO₄) constituent and at least one phosphonate (PO₃) constituent in addition to at least one metal chelate, with it most preferred that a composition comprising at least one potassium phosphonate and at least one potassium phosphate be used. A mixture of mono- and dipotassium phosphonate salts can be readily used as the potassium salt, and a mixture of mono- di- and tripotassium phosphate salts can be readily used as the phosphate salt. Once the composition is formed, it can be applied to plants to prevent infection by Phytophthora infestans and manifestations related to the infection. The composition can be applied as either a dry mix or an aqueous solution to plants prior to infection by the Phytophthora infestans organism.

The composition for preventing Phytophthora infestans contains a combination of phosphonate and phosphate constituents. Any of a variety of phosphates are suitable for use, including K₂HPO₄, K₃PO₄, KH₂PO₄, (NH₃)₂ HPO₄, (NH₃) H₂PO₄, and combinations thereof. The phosphonates, like the phosphates, can be selected from any of a variety of compositions, including K₂HPO₃, KH₂PO₃ (NH₃)₂ HPO₃, (NH₃) H₂PO₃, and combinations thereof. Any phosphate and phosphonate constituent combination can be used as long as infection by and manifestation of Phytophthora infestations is inhibited. Additionally, it is necessary for the constituents to have suitable solubility in a carrier and to be of a constitution to allow easy distribution in an area where plants to be treated are grown. More preferably, the phosphonate and phosphate constituents, when combined, will have a synergistic effect in inhibiting Phytophthora infestans. The most preferred phosphate (PO₄) and phosphonate (PO₃) constituents for use in preventing Phytophthora infestans infection are combinations of K₂HPO₃ and K₂HPO₄. As such, the phosphate (PO₄) and phosphonate (PO₃) constituents are combined to form the composition used to prevent Phytophthora infestans infection.

While the discussed constituents are preferred for use in treating plants and preventing infection by the Phytophthora organism, variations of the phosphate and phosphonate constituents can be used. As such, it is preferred if the compound comprises a fungicidally effective amount of at least a first salt having the following formula:

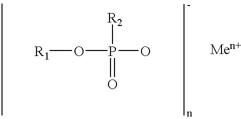

and a second salt having the following formula:

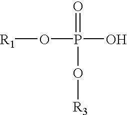

where R₁ is selected from the group consisting of H, K, an alkyl radical containing from 1 to 4 carbon atoms, halogen-substituted alkyl or nitro-substituted alkyl radical, an alkenyl, halogen-substituted alkenyl, alkynl, halogen-substituted alkynl, alkoxy-substituted alkyl radical, ammonium substituted by alkyl and hydroxy alkyl radicals;

R₂ and R₃ are selected from a group consisting of H and K;

Me is selected from a group consisting of K, alkaline earth metal cations, aluminum atom, and the ammonium cation; and

n is a whole number from 1 to 3, equal to the valence of Me.

Optionally, the second salt can be of the formula:

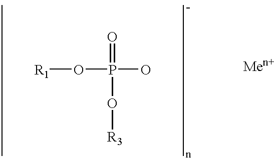

with the above listed formula constituents still applicable.

The constituents should be preferably mixed with a suitable carrier to facilitate distribution to an area where the plants to be treated are grown. The carrier should be agriculturally acceptable, with water (H₂O) most preferred.

As an example of how to form the composition, it is preferred to first form a potassium phosphonate aqueous solution, with the phosphonate formation as follows:

H₃PO₃ is produced by the hydrolysis of phosphorus trichloride according to the reaction: PC1₃+3H₂O→H₃PO₃+3HCl. The HCl is removed by stripping under reduced pressure, and the phosphonic acid (H₃PO₃) is sold as a 70% acid solution.

The phosphonic acid is then neutralized in aqueous solution by potassium hydroxide according to the reactions: H₃PO₃+KOH [symbol] KH₂PO₃+H₂O KH₂PO₃+KOH [symbol] K₂HPO₃+H₂O

to about pH 6.5, and to produce a 0-22-20 liquid weighing 11.15 lbs./gal. This solution is commercially available and is sold under the trademark “Phos-Might” by Foliar Nutrients, Inc., Cairo, Ga. 31728.

The phosphate (PO₄) is produced by reacting mono potassium phosphate (0-51.5-34) with 45% potassium hydroxide in aqueous solution to produce dipotassium phosphate, by the following reaction: KH2PO₄+KOH [symbol] K₂HPO₄+H₂O with a product density of 1.394 g/mL at 20° C. and a solution pH of 7.6 producing a 0-18-20 analysis. This solution is commercially available and is sold under trademark “K-Phos” by Foliar Nutrients, Inc., Cairo, Ga. 31724.

After the potassium phosphonate and potassium phosphate constituents, or other phosphonate and phosphate constituents, are formed, they can be combined to produce the potassium phosphonate and potassium phosphate composition, e.g. a mixture of the potassium salts of PO₃ and PO₄. The phosphonate and phosphate composition can then be combined with the metal chelate to form the composition of the invention. This composition is used to then treat plants for the prevention of infection by the Phytophthora genus, especially Phytophthora infestans.

Varying amounts of each compound, for example, K₂HPO₃, KH₂PO₃, K₂HPO₄, or KH₂PO₄ in an aqueous solution, are combined at rates ranging from 0.1 millimolar to 1000 millimolar, preferably 1 millimolar to 500 millimolar, more preferably 5 millimolar to 300 millimolar, and most preferably 20 millimolar to 200 millimolar, depending on crop host and the pathogen complex and level of infection. A 5% vol./vol. aqueous solution of K₂HPO₄ is equivalent to 2.6% by weight and is approximately 151 millimolar, and a 5% vol./vol. aqueous solution of K₂HPO₃ is equivalent to 2.7% by weight and is approximately 173 millimolar. A 20 millimolar aqueous solution of K₂HPO₄ is equivalent to 0.35% by weight, and a 20 millimolar aqueous solution of K₂HPO₃ is equivalent to 0.32% by weight. Alternatively, the amount of the first salt is equal to one part by weight and the amount of the second salt is equal to between 0.001 and 1,000 parts by weight, i.e. the weight ratio of first salt to second salt is 1:0.001 to 1:1,000. It is preferred if the aqueous composition is comprised of 21.7% K₂HPO₄ and 21.5% K₂HPO₃ or 11.8% PO₄ and 10.7% PO₃, all of which are soluble.

Once formed, the composition will be applied to various plants to prevent fungus infection, particularly infection by the Phytophthora genus, and more particularly Phytophthora infestans infection. The preferable method of application is foliar, either by ground or aerial equipment, but is not limited to that method alone. Injection or soil applications, for example, could also be efficacious depending on specific crops and pathogens. While it is preferred to apply the composition in an aqueous solution, other forms of application may be used, including dusts, flowables, water dispersable granules, granules and inert emulsions, as well as oils. At least one application should be made; however, multiple applications of the composition can be made.

The inventive composition has utility on fruit crops, agronomic crops, ornamentals, trees, grasses, vegetables, grains, and floricultural crops, as well as some aquatic crops, including water cress. The crops most likely infected by Phytophthora infestans are potatoes (Solanum tuberosum) and tomatoes (Lycopersicon esculentum). As such, the present composition is especially useful in treating potato and tomato plants to prevent Phytophthora infection.

The following examples set forth the preferred concentrations and techniques for formulation thereof, as well as methods of application, use and test results demonstrating the efficacy of the inventive concentration in protecting plants against attack by Phytophthora infestans. It is to be understood, however, that these Examples are presented by way of illustration only, and nothing therein shall be taken as a limitation upon the overall scope of the invention. The specific components tested in the Examples were prepared and applied as follows.

In each of Examples 11 and 12, treatments were applied as a one gallon solution by a back pack sprayer, maintained at about 60 psi, in sufficient quantities of water to achieve thorough coverage. The spray rate used was equivalent to approximately 25 gallons per acre. All treatments were applied to the appropriate number of experimental units assigned in a randomized complete block (CRB) design replicated four times.

As used in the following examples, “Percent Late Blight” means the percent of plants that exhibit blight. “Lesions Per Plant” relate to the number of lesions on a particular plant caused by the infectious inoculum. The “No. Infected Leaflets” relates to the number of infected leaves per plant.

### Example 11

Potatoes (Solanum tuberosum, variation Atlantic) were infected with a pathogen, Phytophthora infestans, to determine whether suitable treatments could be developed to eliminate the pathogen from the infected plants and, more importantly, prevent infection of the plants by the pathogen. The Phytophthora pathogen causes late blight in infected plants. The plants were treated with the below listed compositions, twice, with the applications being seven (7) days apart. The composition of the inoculant added to the plants is listed below in the table. One week (7 days) after the last inoculation was made to the plants, the potato plants were then infected with the pathogen, Phytophthora infestans. The infectious inoculum was equal to 12,000 sporangia per millimeter (ml), with 20 ml administered per plant. The Genotype of the pathogen was US-8 and the Matingtype was A2. Seven days after inoculation with the pathogen, the results were tabulated to determine the percentage of blight in the plants and the number of lesions per plant. Additionally, the number of infected leaflets per plant were tabulated. The results are as follows:

SUMMARY LATE BLIGHT OBSERVATIONS
GREENHOUSE EXPERIMENT

| | | | | NO. |
|---|---|---|---|---|
| | | | LESIONS | INFECTED |
| | | % LATE | PER | LEAFLETS |
| TREATMENT | RATE/ACRE | BLIGHT | PLANT | PER PLANT |
| K₂HPO₃ | 1% v/v | 0.39 | 0.5 | 0.5 |
| + | + | | | |
| K₂HPO₄ | 1% v/v | | | |
| Cu—EDDHA | 0.2 lb. AI | 12.30 | 35.3 | 26.9 |
| K₂HPO₃ | 1% v/v | 1.85 | 2.4 | 1.8 |
| K₂HPO₄ | 1% v/v | 18.45 | 41.4 | 31.1 |
| CONTROL | | 28.12 | 84.4 | 50.1 |

Tests were made on single 6″ pots × 4 reps in CRB design.

As can be seen, an inoculum of just phosphonate (PO₃) showed good results in controlling the blight. However, better results were achieved using the phosphate (PO₄) and phosphonate (PO₃) composition. The (PO₄) and (PO₃) combination demonstrated exceptional blight depression, indicating that potato blight can be better controlled using a composition comprised of (PO₃) and (PO₄). This indicates that a synergistic effect is achieved with a (PO₃) and (PO₄) combination.

### Example 12

Tomatoes (Lycopersicon esculentum, FL 40) were infected with a pathogen, Phytophthora infestans, to determine whether suitable treatments could be developed to prevent infection of the plants by the pathogen. The Phytophthora pathogen causes late blight in infected plants. The plants were treated with the below listed compositions, twice, with the application dates being seven (7) days apart. The composition of the inoculant added to the plants is listed below in the table. One week (7 days) after last inoculation was made to the plants, the tomato plants were then infected with the pathogen, Phytophthora infestans. The infectious inoculum was equal to 12,000 sporangia per millimeter (ml), with 20 ml administered per plant. The Genotype of the pathogen was US-17 and the Matingtype was A1. Seven days after inoculation with the pathogen, the results were tabulated to determine the percentage of blight in the plants and the number of lesions per plant. Additionally, the number of infected leaflets per plant were tabulated. The results are as follows:

GREENHOUSE TOMATO LATE BLIGHT TRIAL

| | | | NO. |
|---|---|---|---|
| | | | INFECTED |
| | | LESIONS | LEAFLETS |
| TREATMENT | RATE/ACRE | PER PLANT | PER PLANT |
| K₂HPO₃ | 2% v/v | 6.0 | 2.5 |
| + | | | |
| K₂HPO₄ | | | |
| SIMAZINE 4L | 0.1 lb. AI | 52.3 | 36.8 |
| K₂HPO₃ | 1% v/v | 56.7 | 21.5 |
| K₂HPO₄ | 1% v/v | 74.8 | 36.5 |
| CONTROL | | 66.8 | 33.8 |

Excellent results were achieved using the phosphate (PO₄) and phosphonate (PO₃) composition. The (PO₄) and (PO₃) combination demonstrated exceptional blight depression, indicating that the blight can be better controlled using a composition comprised of (PO₃) and (PO₄). This indicates that a synergistic effect is achieved with a (PO₃) and (PO₄) combination.

The above Examples demonstrate that the inventive compositions are useful in protecting plants against attack by the Phytophthora infestans infection with the application of one solution.

The disclosures in all references cited herein are incorporated by reference.

Alternatively, the composition of the invention can be used to prevent infection by Phycomycetes, Ascomycetes, and other fungal pathogens, as well as bacteria.

In the following Examples, the composition of the samples tested are as follows:

Sample 1: 15.1% K₂HPO₃+15.1% K₂HPO₄+69.8% inert ingredients (H₂O)

Sample 2: Cu EDDHA (3.2% Cu)−0.2 1b Al/100 gal.

Sample 3: 80% v/v Sample 1+1 lb. 6% Fe-EDDHA

Sample 4: 80% v/v Sample 1+20% v/v 6% Mn-EDTA

Sample 5: 80% v/v Sample 1+20% v/v 10% Zn-EDTA

Sample 6: 80% v/v Sample 1+10% v/v 6% Mn-EDTA +10% v/v 10% Zn-EDTA

Sample 7: 80% v/v Sample 1+0.2 lb. AI/100 gal. (Cu-EDDHA)

### Example 13

Single 5 gal. containers of live oak trees (Quercus Va.), inoculated with Phyllactinia guttata, were treated using a SOLO backpack sprayer at 60 psi at 25 gpa using the following compositions. Treatments were replicated four times and assigned in a randomized complete block design.

LIVE OAK POWDERY MILDEW TRIAL

| | | DISEASE SEVERITY | | |
|---|---|---|---|---|
| | RATE/100 GALLONS | PRE- | POST- | PHYTO- |
| TREATMENT | (V/V) | APPLICATION 4/20 | APPLICATION 6/15 | TOXICITY |
| 1) Sample 1 | 2 gal. | 3.0 | 2.0 | 0 |
| 2) Sample 2 | 0.2 lb. AI | 2.75 | 2.5 | 0 |
| 3) Sample 3 | 2 gal. | 2.5 | 2.0 | 0 |
| 4) Sample 4 | 2 gal. | 3.0 | 1.5 | 0 |
| 5) Sample 7 | 2 gal. | 3.0 | 1.0 | 0 |
| 6) CONTROL | — | 3.0 | 4.0 | 0 |

Powdery Mildew—Phyllactinia guttata

Appl. Dates: Apr. 27, May 11, Jun. 1, and Jun. 15, 2000

Rated Jun. 15, 2000, Clay County, Fla.

Disease Severity 1-5: 1=1-10%, 2=11-25%, 3=26-50%, 4=51-75% and 5=76-100%

PHYTOTOXICITY RATINGS: 0-10 0=no phytotoxicity, 10=100% kill

### Example 14

Single 5 gal. containers of live dogwoods (Cornus florida), inoculated with Oidium spp., were treated using a SOLO backpack sprayer at 60 psi at 25 gpa using the following compositions. Treatments were replicated four times and assigned in a randomized complete block design.

DOGWOOD POWDERY MILDEW TRIAL

| | | DISEASE SEVERITY | | |
|---|---|---|---|---|
| | RATE/100 GALLONS | PRE-EXISTING | POST-APLICATION | PHYTO- |
| TREATMENT | (V/V) | 4/27 | 6/15 | TOXICITY |
| 1) Sample 1 | 2 gal. | 2.5 | 1.5 | 0 |
| 2) Sample 4 | 2 gal. | 3.0 | 1.0 | 0 |
| 3) Sample 5 | 2 gal. | 2.5 | 1.5 | 0 |
| 4) Sample 6 | 2 gal. | 2.0 | 1.75 | 0 |
| 5) Sample 7 | 2 gal. | 2.5 | 1.0 | 0 |
| 6) CONTROL | — | 2.75 | 3.0 | 0 |

Powdery Mildew—Oidium spp.

Appl. Dates: Apr. 27, May 11, May 25, and Jun. 8, 2000

Rated Jun. 15, 2,000

Disease Severity 1-5: 1=1-10%, 2=11-25%, 3=26-50%, 4=51-75% and 5=76-100%

PHYTOTOXICITY RATINGS: 0-10 0=no phytotoxicity, 10=100% kill

In Example 13 above, formulation Sample 7 demonstrates that the pre-application Disease Severity factor as measured on Apr. 20, 2000, of 3.0 was reduced to 1.0 demonstrating the combination phosphate, phosphonates and Cu EDDHA (a metal chelate) is effective in treating the live oak powdery mildew. Similarly, Example 14 demonstrates that formulations Sample 4 (PO₃+PO₄+Mn EDTA) and Sample 7 (PO₃+PO₄+Cu EDDHA) are effective in treating dogwood powdery mildew as evidenced in disease severity from 3.0 to 1.0 and 2.5 to 1.0, respectively.

Thus, there has been shown and described a method of use for fungicidal and bactericidal compositions, which provide improved efficacy in controlling fungi and bacterial infections in plants. More particularly, the compositions and method related to metal chelates, and preferably a copper chelate in the form of Cu-EDDHA (disodium cupric ethylenediamine-di-o-hydroxyphenylacetic acid), in an aqueous solution, also including an effective amount of phosphate (PO₄) and phosphanate (PO₃), which fulfills all the objects and advantages sought therefore. It is apparent to those skilled in the art, however, that many changes, variations, modifications, and other uses and applications for the subject fungicidal and bactericidal compositions are possible and, also, such changes, variations, modifications, and other uses and applications which do not depart from the spirit and scope of the invention are deemed to be covered by the invention which is limited only by the claims which follow.

What is claimed is:

1. A composition for preventing and controlling fungicidal and bacterial diseases in plants, said composition comprising effective amounts of:
(a) at least one first salt having the following formula: 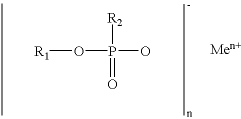
(b) at least one second salt selected from compounds having the formula: 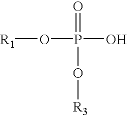
or the formula: 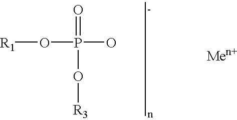
where R¹ is selected from the group consisting of H, K, an alkyl radical containing from 1 to 4 carbon atoms, halogen-substituted alkyl or nitro-substituted alkyl radical, an alkenyl, halogen-substituted alkenyl, alkynl, halogen-substituted alkynl, alkoxy-substituted alkyl radical, ammonium substituted by alkyl or hydroxy alkyl radicals;
R₂ and R₃ are selected from the group consisting of H and K;
Me is selected from the group consisting of K, alkaline earth metal cations, an aluminum atom, and an ammonium cation;
n is a whole number equal to between 1 and 3, equal to the valence of Me; and
(c) at least one metal chelate wherein said metal is a metal selected from rows 4 or 5 of the periodic table of the elements.

2. The composition of claim 1 wherein said metal chelate is present in said aqueous solution in amount equal to from about 0.01 to about 2 pounds AI per acre.

3. The composition of claim 2 wherein said metal chelate is present in said aqueous solution in amount equal to from about 0.01 to about 0.8 pounds AI per acre.

4. The composition of claim 1 wherein said metal is a metal selected from row 4 of the periodic table of the elements.

5. The composition of claim 1 wherein said metal chelate has a solubility equal to about 100% where at least 80 pounds of said metal chelate are dissolved in 100 gallons of water at 50° C.

6. The composition of claim 1 wherein said metal chelate is added as an aqueous solution containing an amount of metal chelate (on a metal basis) equal to between 1% and 5% by weight of the aqueous solution.

7. The composition of claim 1 wherein said metal constituent is selected from the group consisting of iron, zinc, tin, manganese, copper, and combinations thereof.

8. The composition of claim 7 wherein said metal constituent is selected from the group consisting of zinc, manganese, copper, and combinations thereof.

9. The composition of claim 8 wherein said metal chelate is selected from the group consisting of Cu-EDDHA, Cu-pEDDHA, Cu-EDDHMA, and combinations thereof.

10. The composition of claim 1 wherein said chelate constituent is selected from the group consisting of pEDDHA, EDDHA, and EDDHMA.

11. The composition of claim 1 wherein said first salt is selected from the group consisting of K₂HPO₃, KH₂PO₃, (NH₃) H₂PO₃, and (NH₃)₂ HPO₃; and said second salt is selected from the group consisting of K₂HPO₄, KH₂PO₄, K₃PO₄, (NH₃)₂HPO₄, H₃)H₂PO₄, and (NH₃)₃PO₄.

12. The composition of claim 1 wherein said composition is in an aqueous solution, wherein each said first and second salt is present in solution from about 0.1 millimolar to about 1000 millimolar.

13. The composition of claim 12 wherein said composition is in an aqueous solution, wherein each said first and second salt is present in solution from about 20 millimolar to about 200 millimolar.

14. The composition of claim 1 wherein the weight ratio of said first salt to said second salt is 1:0.001 to 1:1,000.

15. The composition of claim 1 wherein said composition treats or prevents diseases caused by Phytophthora.

16. The composition of claim 15 wherein said composition treats or prevents diseases caused by Phytophthora infestans.

17. The composition of claim 1 wherein the plants are tomato and potato species.

18. A method for controlling fungicidal and/or bacterial disease wherein said method comprises applying to a plant fungicidally and/or bactericidally effective amounts of at least one metal chelate, at least one phosphate salt, and at least one phosphonate salt in aqueous solution, wherein said phosphonate salt has the formula: 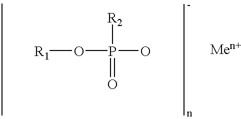
said phosphate salt is selected from compounds having the formula: 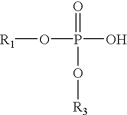
or the formula: 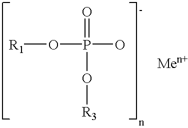
where R₁ is selected from the group consisting of H, K, an alkyl radical containing from 1 to 4 carbon atoms, halogen-substituted alkyl or nitro-substituted alkyl radical, an alkenyl, halogen-substituted alkenyl, alkynl, halogen-substituted alkynl, alkoxy-substituted alkyl radical, ammonium substituted by alkyl or hydroxy alkyl radicals;
R₂ and R₃ are selected from the group consisting of H and K;
Me is selected from the group consisting of K, alkaline earth metal cations, an aluminum atom, and an ammonium cation;
n is a whole number equal to between 1 and 3, equal to the valence of Me; and said metal is a metal selected from rows 4 or 5 of the periodic table of the elements.

19. The method of claim 18 wherein said metal chelate is present in said aqueous solution in amount equal to from about 0.01 to about 2 pounds AI per acre.

20. The method of claim 19 wherein said metal chelate is present in said aqueous solution in amount equal to from about 0.01 to about 0.8 pounds AI per acre.

21. The method of claim 18 wherein said metal is a metal selected from row 4 of the periodic table of the elements.

22. The method of claim 18 wherein said metal chelate has a solubility equal to about 100% where at least 80 pounds of said metal chelate are dissolved in 100 gallons of water at 50° C.

23. The method of claim 18 wherein said metal chelate is added as an aqueous solution containing an amount of metal chelate (on a metal basis) equal to between 1% and 5% by weight of the aqueous solution.

24. The method of claim 18 wherein said metal constituent is selected from the group consisting of iron, zinc, tin, manganese, copper, and combinations thereof.

25. The method of claim 24 wherein said metal constituent is selected from the group consisting of zinc, manganese, copper, and combinations thereof.

26. The method of claim 25 wherein said metal chelate is selected from the group consisting of Cu-EDDHA, Cu-pEDDHA, Cu-EDDHMA, and combinations thereof.

27. The method of claim 18 wherein said chelate constituent is selected from the group consisting of pEDDHA, EDDHA, and EDDHMA.

28. The method of claim 18 wherein said first salt is selected from the group consisting of K₂HPO₃, KH₂PO₃, (NH₃) H₂PO₃, and (NH₃)₂ HPO₃; and said second salt is selected from the group consisting of K₂HPO₄, KH₂PO₄, K₃PO₄, (NH₃)₂HPO₄, (NH₃)H₂PO₄, and (NH₃)₃PO₄.

29. The method of claim 18 wherein said composition is in an aqueous solution, wherein each said first and second salt is present in solution from about 0.1 millimolar to about 1000 millimolar.

30. The method of claim 30 wherein said composition is in an aqueous solution, wherein each said first and second salt is present in solution from about 20 millimolar to about 200 millimolar.

31. The method of claim 18 wherein the weight ratio of said first salt to said second salt is 1:0.001 to 1:1,000.

32. The method of claim 18 wherein said composition treats or prevents diseases caused by Phytophthora.

33. The method of claim 32 wherein said composition treats or prevents diseases caused by Phytophthora infestans.

34. The method of claim 18 wherein the plants are tomato and potato species.

35. A method of controlling fingicidal and/or bactericidal disease in plants comprising applying to the plants in enhanced fungicidally and/or bactericidally effective amounts an aqueous composition comprising:
(a) an aqueous solution of H₃PO₃ and KOH,
(b) an aqueous solution of monopotassium phosphate and KOH, and
(c) a metal chelate wherein said metal is a metal selected from rows 4 or 5 of the periodic table of the elements.

36. The method of claim 35 wherein the amount of potassium phosphonate in said aqueous solution (a) and the amount of potassium phosphate in said aqueous solution (b) is each present in said composition in an amount from about 0.1 millimolar to about 1000 millimolar

37. The method of claim 35 wherein the weight ratio of potassium phosphonate prepared from solution (a) in said composition to potassium phosphate prepared from solution (b) in said composition is 1:0.001 to 1:1,000.

38. The method of claim 35 wherein said metal chelate is present in said aqueous solution in amount such that the metal is applied to the plants at a rate of from about 0.01 to about 2 pounds AI per acre.

39. The method of claim 35 wherein said chelate constituent is selected from pEDDHA, EDDHA, EDDHMA or combinations thereof, and said metal is selected from iron, zinc, tin, manganese, copper, and combinations thereof.

40. A method of controlling fungicidal and/or bactericidal disease in plants comprising applying to the plants in enhanced fungicidally and/or bactericidally effective amounts an aqueous composition prepared by mixing:
(a) an aqueous solution of H₃PO₃ and KOH,
(b) an aqueous solution of monopotassium phosphate and KOH, and
(c) a metal chelate wherein said metal is a metal selected from rows 4 or 5 of the periodic table of the elements.

41. The method of claim 40 wherein the amount of potassium phosphonate in said aqueous solution (a) and the amount of potassium phosphate in said aqueous solution (b) is each present in said composition in an amount from about 0.1 millimolar to about 1000 millimolar

42. The method of claim 40 wherein the weight ratio of potassium phosphonate prepared from solution (a) in said composition to potassium phosphate prepared from solution (b) in said composition is 1:0.001 to 1:1,000.

43. The method of claim 40 wherein said metal chelate is present in said aqueous solution in amount such that the metal is applied to the plants at a rate of from about 0.01 to about 2 pounds AI per acre.

44. The method of claim 40 wherein said chelate constituent is selected from pEDDHA, EDDHA, EDDHMA or combinations thereof, and said metal is selected from iron, zinc, tin, manganese, copper, and combinations thereof.

45. A method of controlling fungicidal and/or bactericidal disease in plants comprising applying to the plants in enhanced fungicidally and/or bactericidally effective amounts an aqueous composition comprising:
(a) an aqueous solution of H₃PO₃ and KOH,
(b) an aqueous solution of dipotassium phosphate, and
(c) a metal chelate wherein said metal is a metal selected from rows 4 0 or 5 of the periodic table of the elements.

46. The method of claim 45 wherein the amount of potassium phosphonate in said aqueous solution (a) and the amount of potassium phosphate in said aqueous solution (b) is each present in said composition in an amount from about 0.1 millimolar to about 1000 millimolar

47. The method of claim 45 wherein the weight ratio of potassium phosphonate prepared from solution (a) in said composition to potassium phosphate prepared from solution (b) in said composition is 1:0.001 to 1:1,000.

48. The method of claim 45 wherein said metal chelate is present in said aqueous solution in amount such that the metal is applied to the plants at a rate of from about 0.01 to about 2 pounds Al per acre.

49. The method of claim 45 wherein said chelate constituent is selected from pEDDHA, EDDHA, EDDHMA or combinations thereof, and said metal is selected from iron, zinc, tin, manganese, copper, and combinations thereof.

50. A method of controlling fungicidal and/or bactericidal disease in plants comprising applying to the plants in enhanced fungicidally and/or bactericidally effective amounts an aqueous composition prepared by mixing:
(a) an aqueous solution of H₃PO₃ and KOH,
(b) an aqueous solution of dipotassium phosphate, and
(c) a metal chelate wherein said metal is a metal selected from rows 4 or 5 of the periodic table of the elements.

51. The method of claim 50 wherein the amount of potassium phosphonate in said aqueous solution (a) and the amount of potassium phosphate in said aqueous solution (b) is each present in said composition in an amount from about 0.1 millimolar to about 1000 millimolar

52. The method of claim 50 wherein the weight ratio of potassium phosphonate prepared from solution (a) in said composition to potassium phosphate prepared from solution (b) in said composition is 1:0.001 to 1:1,000.

53. The method of claim 50 wherein said metal chelate is present in said aqueous solution in amount such that the metal is applied to the plants at a rate of from about 0.01 to about 2 pounds AI per acre.

54. The method of claim 50 wherein said chelate constituent is selected from pEDDHA, EDDHA, EDDHMA or combinations thereof, and said metal is selected from iron, zinc, tin, manganese, copper, and combinations thereof.
